(19) United States
(12) Patent Application Publication
(10) Pub. No.: US 2005/0117470 A1
(43) Pub. Date: Jun. 2, 2005

(54) Optical disk drive, information reproducing method and information storage medium

(75) Inventors: Shunsuke Kimura, Yokohama-shi (JP); Satoru Maeda, Yokohama-shi (JP); Minoru Yonezawa, Yokohama-shi (JP); Hiroharu Satoh, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/994,526

(22) Filed: Nov. 23, 2004

(30) Foreign Application Priority Data
Nov. 28, 2003 (JP) 2003-400916

(51) Int. Cl. G11B 7/00; G11B 7/24

(52) U.S. Cl. 369/44.28; 369/275.4

(57) ABSTRACT

An optical head is fed to the innermost area of an optical disk, and then fed to the outside while a detector circuit measures the frequency of a read signal supplied from the optical head. When the frequency of the read signal changes to high frequency, a tracking servo is performed, and the read signal is analyzed to acquire positional information during the tracking servo operation. The tracking servo operation is disabled, and the optical head is fed to a target position based on the positional information.

### CROSS-REFERENCE TO RELATED APPLICATIONS

This application is based upon and claims the benefit of priority from prior Japanese Patent Application No. 2003-400916, filed Nov. 28, 2003, the entire contents of which are incorporated herein by reference.

### BACKGROUND OF THE INVENTION

1. Field of the Invention

The present invention relates to an information storage medium having a burst cutting area and a lead-in area at the disk inner circumference. The present invention further relates to an information reproducing method and information recording/reproducing apparatus for the storage medium.

2. Description of the Related Art

The innermost circumferential area of optical disks such as DVDs and CDs has a lead-in area in which management information such as the attributes of the disk is recorded. The lead-in area is decoded, and thereby, an optical disk drive can determine the kind of disk, such as DVD-ROM and DVD-RAM. The outer circumference of the lead-in area is provided with a data area in which data such as compressed video images and audio are recorded. Thus, the optical disk drive must determine the foregoing areas, and read information recorded therein.

The technique disclosed in JPN. PAT. APPLN. KOAKI Publication No. 11-353661 is given as the method of determining the recording area and non-recording area from the difference in amplitude between information reproducing signals from the areas.

Recently, DVD affiliated companies have developed a next-generation DVD (hereinafter, referred to as HD-DVD) having a recording capacity greatly exceeding conventional DVDs. The following proposal has been made in the HD-DVD. More specifically, the HD-DVD is provided with system lead-in areas and data lead-in area, which have a mutually different information recording format, at the disk inner circumference. The inner circumferential side of the lead-in areas is further provided with an area calling a burst cutting area (BCA). Therefore, the disk drive must accurately determine the foregoing areas when recording or reproducing information using an optical head.

In order to reproduce the optical disk, the system lead-in area must first be read. However, the method of properly accessing the system lead-in area is not still established in the HD-DVD.

### BRIEF SUMMARY OF THE INVENTION

An HD-DVD has neighboring BCA and system lead-in area, which are positioned successively from the inner circumference. The frequency of a reproducing signal is different in each of these BCA and system lead-in areas. Thus, the frequency of the reproducing signal is measured from the inner circumference, and thereby, it is possible to detect the entry from the BCA to the system lead-in area.

According to one aspect of the present invention, there is provided an optical disk apparatus comprising: an optical head which converges an optical beam to a disk recording surface, and supplies a read signal corresponding to reflected light of the beam; a feed section which feeds the optical head to a disk radial direction; a frequency measuring section which measures a frequency of the read signal; a first feed control section which controls the feed section to feed the optical head from the disk innermost area to the outer area; a tracking section which performs a tracking servo when the frequency of the read signal changes from low to high during the feed of the optical head to the outer area by the first feed control section; an acquisition section which analyzes the read signal during the tracking servo operation to acquire positional information; and a second feed control section which disables the tracking servo operation, and controlling the feed section so that the optical head is fed to a target position based on the positional information acquired by the acquisition section.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a top plan view showing the structure of an HD-DVD;

FIG. 2 is a view showing the structure of each recording layer of a BCA and a system lead-in area;

FIG. 3 is a schematic view showing the disk circumferential direction cross-section in the BCA;

FIG. 4 is a view showing the waveform of an RF signal in the BCA;

FIG. 5 is a schematic view showing the disk cross-section in the system lead-in area;

FIG. 6 is a view showing the waveform of an RF signal in the system lead-in area;

FIG. 7 is a block diagram showing the configuration of an information recording/reproducing apparatus;

FIG. 8 is a flowchart to explain the access method according to a first embodiment of the present invention;

FIG. 9 is a view to explain the range of a recording area in the HD-DVD; and

FIG. 10 is a flowchart to explain the access method according to a second embodiment of the present invention.

### DETAILED DESCRIPTION OF THE INVENTION

### First Embodiment

Embodiments of the present invention will be described below in detail with reference to the accompanying drawings.

The following is an explanation of the waveform of reproduction signal (hereinafter, referred also to as the RF signal) of BCA, mirror area and system lead-in area in an HD-DVD-ROM. As shown in FIG. 1, the HD-DVD is formed with a BCA, mirror area and system lead-in area successively from the inner circumference. If the BCA of the HD-DVD is read, there exist four kinds of frequency signals. The highest frequency of the RF signal is about 275 kHz at the normal rotational speed when reading the BCA. The RF signal level is constant in the mirror area. In the system lead-in area, when reading a 13T signal, the frequency of the RF signal becomes lowest, that is, about 1.25 MHz. Thus, it is possible to determine each area from the waveform of the RF signal.

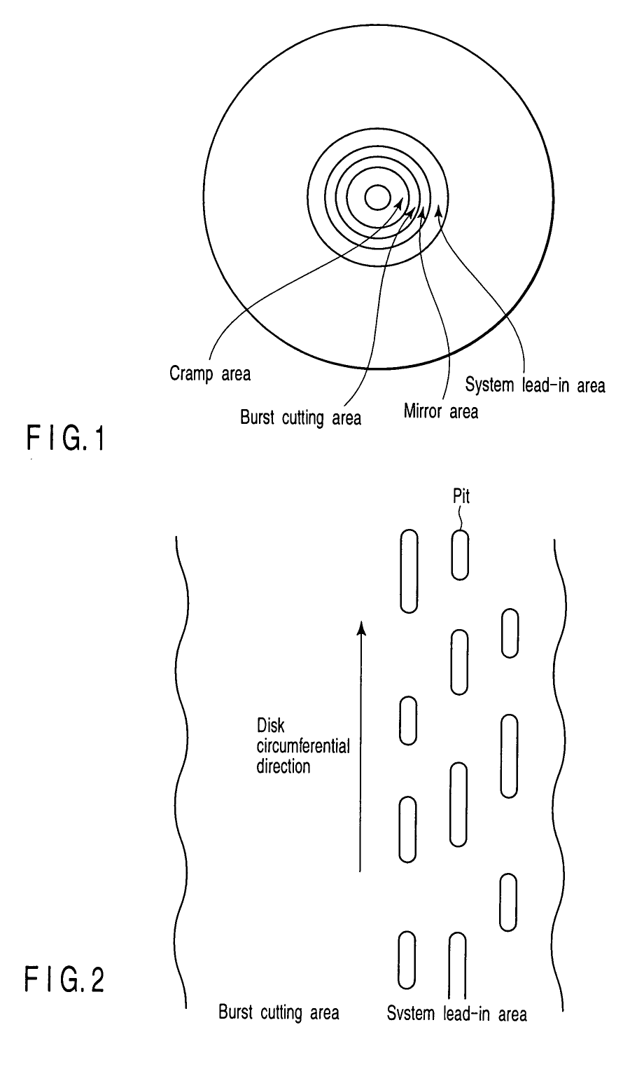

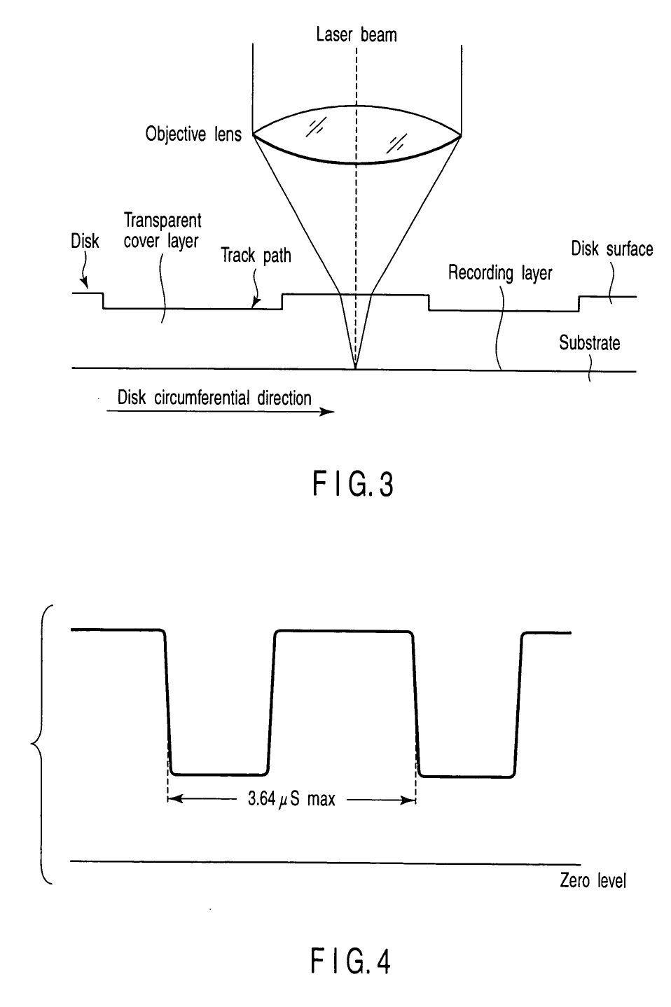

FIG. 2 is a view showing the structure of the BCA and the system lead-in area in the HD-DVD. FIG. 3 is a schematic view showing the disk circumferential direction cross-section in the BCA. FIG. 4 is a view showing the waveform of the RF signal in the BCA. An optical disk to which one embodiment is applied has the following structure. According to the structure, a recording layer is formed on a substrate, and covered with a transparent cover layer. The disk innermost circumferential area is formed with the BCA having predetermined information as concavity and convexity on the surface of the transparent cover layer. The outer side of the BCA is formed with the system lead-in area and the mirror area. The system lead-in area has other predetermined information as embossed pre-pits. The mirror area is interposed between the BCA and the system lead-in area. The mirror area has no information, and its surface is a mirror surface.

The following is an explanation of the waveform of the RF signal of the BCA and the system lead-in area in the HD-DVD-ROM. As described in FIG. 2 and FIG. 3, the recording layer of the BCA has no recorded. Therefore, the waveform of the RF signal is as shown in FIG. 4 according to a radial pattern engraved in the disk surface (i.e., the surface of the transparent cover layer). In the BCA, the radial pattern is formed on the surface of the transparent cover layer like a barcode formed along the disk inner circumference. Predetermined information is recorded using the radial pattern.

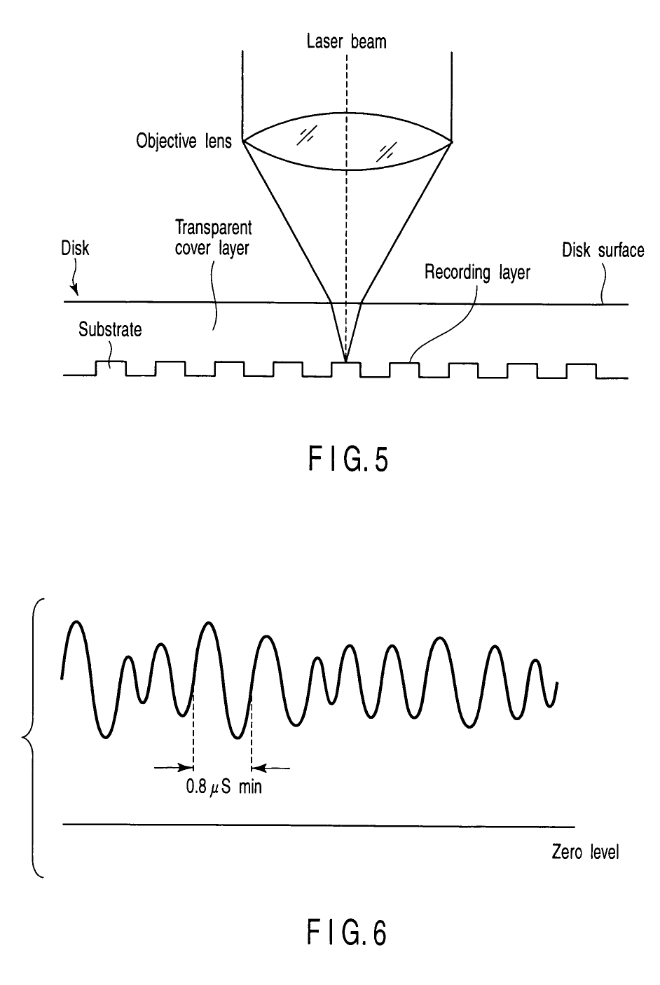

As described above, there exist four kinds of frequency signals in the HD-DVD RF signal when reading the BCA and among the frequency signals the highest frequency is about 275 kHz (3.64 μS). In contrast, in the system lead-in area, the recording layer is formed with embossed pits as illustrated in FIG. 2 and FIG. 5. As seen from FIG. 6, the RF signal has a frequency waveform higher than the BCA. The frequency of the RF signal becomes lowest, that is, 1.25 MHz (0.8 μS) when the 13T signal is read. Thus, the frequency band of the RF signal is different between the BCA and system lead-in areas.

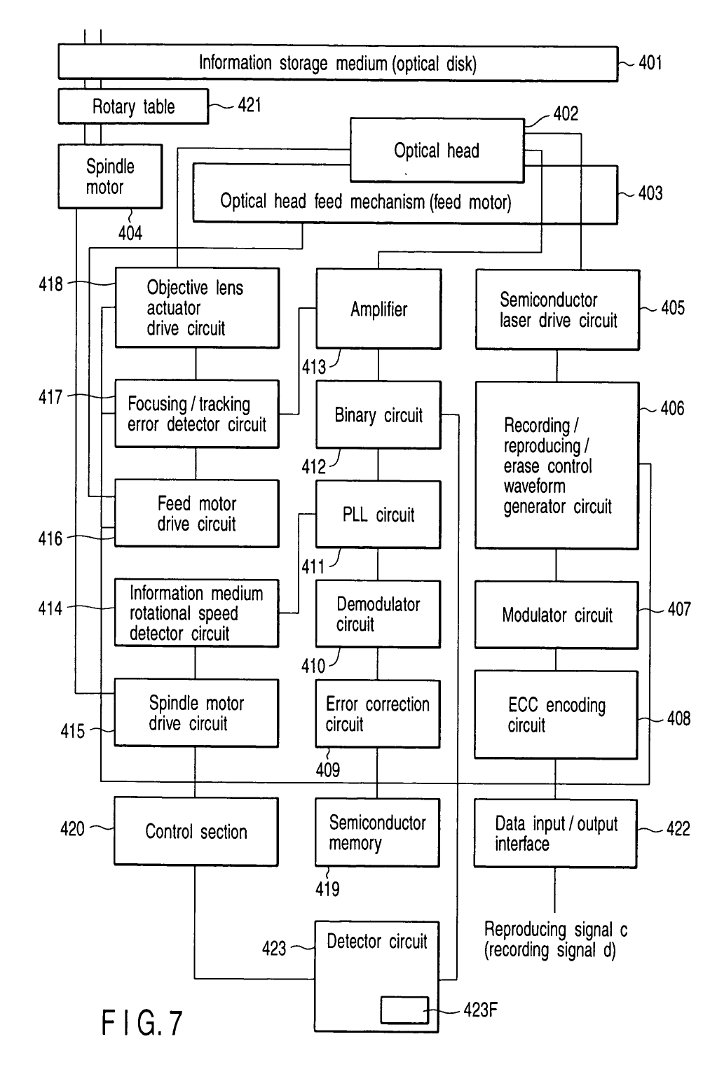

The following is a description of an information recording/reproducing apparatus (an optical disk apparatus) to which one embodiment of the present invention is applied. FIG. 7 is a block diagram showing the configuration of the information recording/reproducing apparatus.

In FIG. 7, 401 denotes an information storage medium (optical disk), 402 denotes an optical head, and 403 denotes a head feed mechanism for controlling the feed of the optical head to the radial direction. A recording signal is input to an ECC encoding circuit 408 via a data input/output interface 422. The recording signal is divided into ECC blocks, and thereafter, supplied to a modulator circuit 407. For example, 8/16-modulated information is input to a recording/reproducing/erase control waveform generator circuit (signal processing circuit) 406, and thereafter, used as a recording signal. The recording signal is supplied to a laser drive circuit 405 to control the intensity of the laser beam of the optical head 402.

In a reproducing operation, a reproducing signal read by the optical head 402 is amplified by an amplifier 413, and input to a binary circuit 412, and thereafter, binarized therein. The binarized signal is input successively to a PLL circuit 411 and demodulator circuit 410. The demodulator circuit 410 performs 16/8-demodulation with respect to the binarized signal. The demodulation signal is error-corrected in an ECC block unit in an error correction circuit 409. In this case, a semiconductor memory 419 is used.

The clock of the PLL circuit 411 is input to a medium rotational speed detector circuit 414. The rotational speed information detected by the medium rotational speed detector circuit 414 is input to a spindle motor control section 415. The spindle motor control section 415 controls the rotation of a motor 404, and drives a rotary table 421 to obtain a desired rotational speed of the optical disk 401.

A feed motor drive circuit 416 controls a feed motor of the head feed mechanism 403 so that the relative position between the optical head 402 and the disk 401 is controlled. A focusing/tracking error detector circuit 417 detects focusing and tracking errors from an optical head signal, and outputs the control signal to an objective lens actuator drive mechanism 418. By so doing, focusing and tracking errors of the optical head 402 are corrected. A control section 420 controls the entirety of the blocks while generating management information to be recorded in the disk in the recording operation. In the reproducing operation, the control section 420 reads the management information and recognizes the reproducing position in the disk 401. A detector circuit 423 has a frequency measuring section 423F. The detector circuit 423 measures the frequency of the RF signal supplied from the optical head 420 via the binary circuit 412, is and thereafter, supplies the measured result to the control section 420.

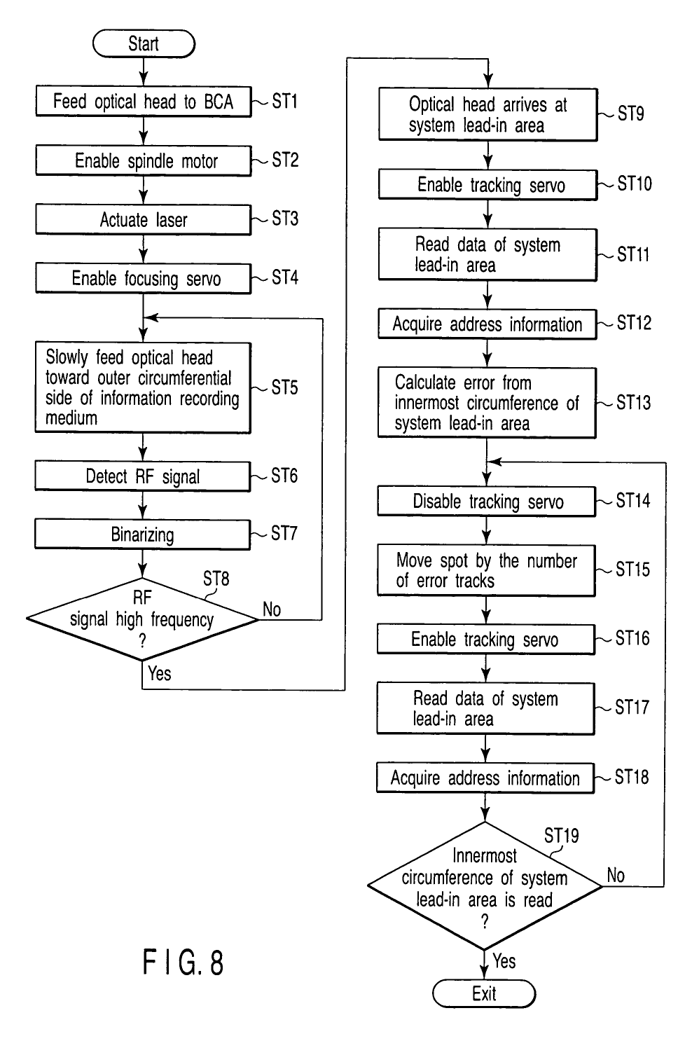

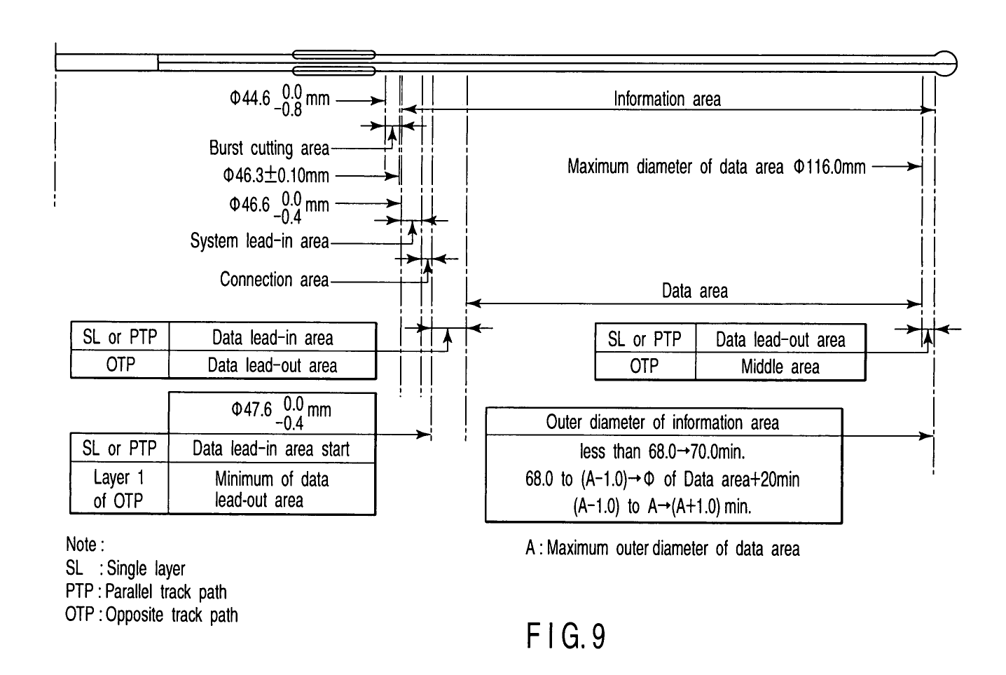

The method of accessing the system lead-in area in the HD-DVD will be described below. FIG. 8 is a flowchart to explain the method of accessing the system lead-in area. FIG. 9 is a view to explain the range of a recording area in the HD-DVD.

The spindle motor 404 is enabled to rotate, and thereafter, the optical head 402 is fed to the innermost BCA in a state that a tracking servo is disabled (step ST1, ST2). In this case, the spindle motor 404 is driven to rotate at a disk linear velocity of 6.51 m/s with respect to an optical beam.

A laser diode (LD) is actuated to enable the focus servo (step ST3, ST4), and thereafter, the optical head 402 is slowly fed toward the outer circumference while detecting the RF signal (step ST5, ST6). In this case, the RF signal is binarized and the detector circuit 423 determines whether or not the frequency of the RF signal is high (step ST7, ST8). In other words, the detector circuit 423 determines whether or not the frequency of the RF signal is higher than a predetermined frequency. If the frequency of the RF signal is not high, the flow returns to step ST5 and the feed of the optical head is continued. If the frequency of the RF signal is high, it is determined that the optical head irradiates the laser beam on the system lead-in area (step ST9).

When the optical head 402 arrives at the system lead-in area, the control section 420 outputs a command to the objective lens actuator drive circuit 418 to enable a tracking servo (step ST10). A converged spot traces a track on the information storage medium 402 while reading (reproducing) the corresponding address or track number (step ST11, ST12).

The control section 420 finds the current converged spot position from the address or track number, and calculates the number of error tracks from the arrival target position (i.e., innermost track in the system lead-in area (step ST13). Thereafter, the control section 420 gives information on the number of tracks required for moving the converged spot to the objective lens actuator drive circuit 418.

If the objective lens actuator drive circuit 418 generates one kick pulse, the objective lens is moved slightly in the radial direction of the information storage medium 402 so that the converged spot moves to the neighboring track. In step ST15, the objective lens actuator drive circuit 418 temporarily disables the tracking servo (step ST14). The kick pulse is generated the number of times corresponding to the information from the control section 420, and thereafter, the tracking servo is again enabled (step ST16).

The control section 420 reproduces information (address or track number) corresponding to the position traced by the converged spot (step ST17) to acquire address information. By so doing, it is confirmed whether or not the target track (innermost track of the system lead-in track) has been accessed. If the target track has not been accessed, the flow returns to step ST14 to carry out the operation for accessing the target track. If the target track has been accessed, the first descriptive data of the system lead-in area is read.

According to the embodiment, the frequency of the largely different read signal is compared between the BCA, mirror and system lead-in areas. By so doing, it is possible to stably read data of system lead-in area when start-up.

### Second Embodiment

The second embodiment of the present invention will be described below.

According to the second embodiment, the time required to begin to reproduce data recoded in the system lead-in area when start-up, is shortened using the mirror area interposed between the BCA and the system lead-in area.

As seen from FIG. 1 and FIG. 9, the mirror area is interposed between the BCA and the system lead-in area. Therefore, during the rotation of the spindle motor 404, the frequency of the RF signal changes from low to zero and then high frequency when the optical head feeds successively to BCA, mirror area and system lead-in area. According to the second embodiment, the optical head feeds across the BCA at high speed, and detection is made such that the frequency of the RF signal is zero in the mirror area. When the detection is made, the feed speed is reduced, so that tracking on the system lead-in area is carried out speedily.

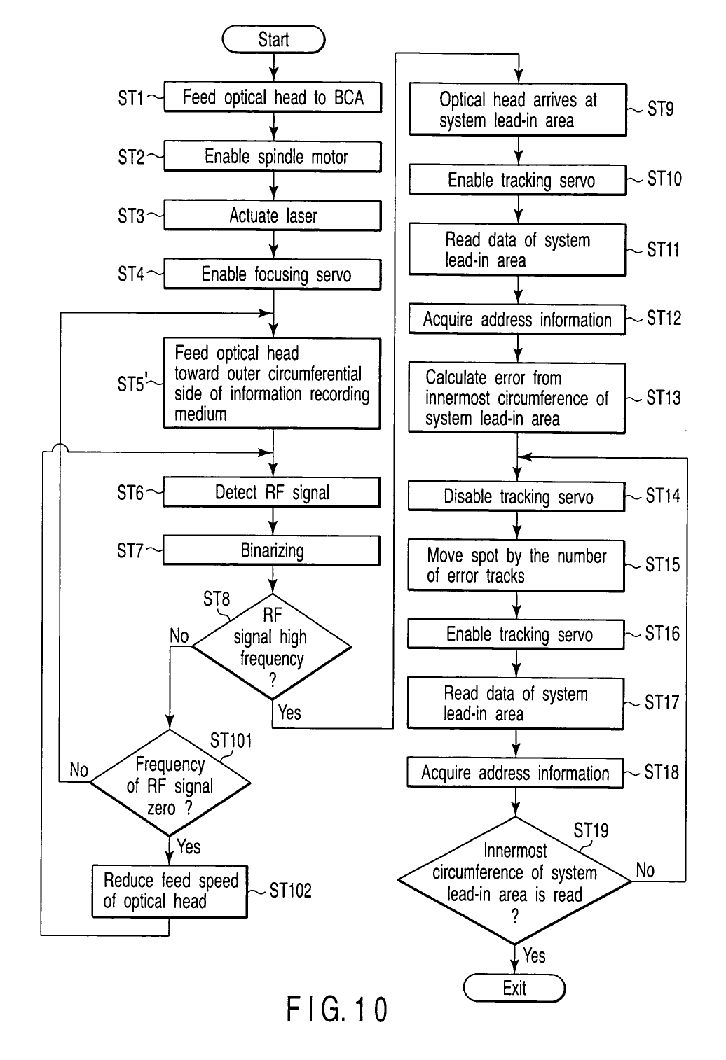

FIG. 10 is a flowchart to explain the operation of the second embodiment. Steps ST101 and ST102 are added to the flowchart of the first embodiment described in FIG. 8. In step ST5′, the optical head is fed at a speed higher than in the first embodiment.

In step ST8, if the frequency of the RF signal is not high, the control section 420 detects whether or not the frequency of the RF signal is substantially zero. If the frequency of the RF signal is zero, it is determined that the optical beam irradiation area is the mirror area, and then, the feed speed of the optical head 402 is reduced (step ST102). Since after the feed speed is reduced, the optical head 402 is positioned in the system lead-in area, tracking is carried out speedily in the system lead-in area. Note that, in step ST8, if it is detected that the frequency of the RF signal is high (thus, when the optical head arrives at the lead-in area without detecting the mirror area), the tracking servo is enabled in the system lead-in area without reducing the feed speed of the optical head as step ST10, and address data of the system lead-in area is read as step ST12. Subsequent process is the same as the first embodiment.

According to the second embodiment, it is possible to shorten the time to read the system lead-in area from start-up (apparatus power-on).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical disk apparatus comprising:
an optical head which converges an optical beam to a disk recording surface, and supplies a read signal corresponding to reflected light of the beam;
a feed section which feeds the optical head to a disk radial direction;
a frequency measuring section which measures a frequency of the read signal;
a first feed control section which controls the feed section to feed the optical head from the disk innermost area to the outer area;
a tracking section which performs a tracking servo when the frequency of the read signal changes to higher frequency than predetermined frequency during the feed of the optical head to the outer area by the first feed control section;
an acquisition section which analyzes the read signal during the tracking servo operation to acquire positional information; and
a second feed control section which disables the tracking servo operation, and controlling the feed section so that the optical head is fed to a target position based on the positional information acquired by the acquisition section.

2. The optical disk apparatus according to claim 1, wherein the frequency measuring section includes a binary section which binarizes the read signal supplied from the optical head, and measures a frequency of the read signal based on the binarized read signal.

3. The optical disk apparatus according to claim 1, further comprising:
a speed reduction section which reduces a feed speed of the optical head when the frequency of the read signal is substantially zero during the feed of the optical head to the outer area by the first feed control section.

4. A method of reproducing information recorded in an optical disk using an optical head converging an optical beam to a disk recording surface, and supplying a read signal corresponding to reflected light of the beam, the method comprising:
feeding the optical head to the innermost area of the optical disk;
feeding the optical head to the outer area while measuring a frequency of a read signal supplied from the optical head;
performing a tracking servo when the frequency of the read signal changes to higher frequency than predetermined frequency; and
analyzing the read signal to acquire positional information, and disabling the tracking servo operation so that the optical head is fed to a target position based on the acquired positional information.

5. An information storage medium comprising:
a substrate;
a recording layer formed on the substrate;
a transparent cover layer formed on the recording layer;
a burst cutting area formed on the surface of the inner circumference of the transparent cover layer, and having first information as concavity and convexity on the surface of the inner circumference of the transparent cover layer;
a system lead-in area formed outside the burst cutting area, and having second information as embossed pre-pits; and
a mirror area interposed between the burst cutting area and the system lead-in area, and having no information.
